(19) United States
(12) Patent Application Publication
(10) Pub. No.: US 2006/0044809 A1
(43) Pub. Date: Mar. 2, 2006

(54) Light reflecting structure

(75) Inventor: Te-Chen Peng, Taipei (TW)

Correspondence Address: BACON & THOMAS, PLLC, 625 SLATERS LANE, FOURTH FLOOR, ALEXANDRIA, VA, 22314, US

(73) Assignee: TECO IMAGE SYSTEMS CO., LTD, Taipei (TW)

(21) Appl. No.: 11/067,686

(22) Filed: Mar. 1, 2005

(30) Foreign Application Priority Data
Sep. 2, 2004 (CN) 2004100769119

(51) Int. Cl. F21V 7/00

(52) U.S. Cl. 362/341

(57) ABSTRACT

A light reflecting structure includes a light source and the at least one reflector. The reflector is disposed in the vicinity of the light source, and includes a plurality of reflecting regions and shading regions discretely arranged at a surface thereof to respectively reflect and shelter the light emitted from the light source, thereby generating a reflective light with substantially identical brightness.

### FIELD OF THE INVENTION

The present invention relates to a light reflecting structure, and more particularly to a light reflecting structure for use in a light-emitting module of an image processing apparatus.

### BACKGROUND OF THE INVENTION

With increasing development, electronic products are more powerful and the sizes thereof are developed toward minimization. In addition to these requirements, the electronic product should have desired quality. For example, reflective scanners are widely used to for scanning opaque objects and processing the image information into analog or digital forms. Examples of the opaque objects include paper sheets, photographs, etc. In order to achieve better image quality, the components of the scanner should be properly selected and assembled. As known, the type of the light source and the brightness of the reflective light are major factors influencing the image quality of the scanner.

A typical scanner comprises a light-emitting module in the lower housing thereof. The light-emitting module has therein several optical elements including a light source, a reflective mirror, a lens set, and a photoelectric conversion device such as a charge coupled device (CCD). When the scanner is operated, the light emitted by the light source is projected onto an opaque object placed on a scanning platform, which is typically a glass platform. The light reflected from the scanned object is incident into the light-emitting module and reflected by the reflective mirror. By means of the lens set, the light reflected from the reflective mirror is focused on the charge-coupled device (CCD) and converted into an electric signal in an analog or digital form.

The light source used in the scanner is usually a linear cathode-ray tube lamp, which is parallel with the moving direction of the light-emitting module. Since the brightness at both sides of the linear cathode-ray tube lamp is weaker than that at the middle portion thereof, the light emitted by this light source fails to be evenly projected onto the scanned object. Therefore, the image quality of the scanned object is impaired.

As the length of the light source is increased, the brightness of the light emitted from the light source becomes more uniform. However, the increase of the length is disadvantageous because the overall volume of the scanner is increased.

### SUMMARY OF THE INVENTION

It is an object of the present invention to provide light reflecting structure for use in a light-emitting module of an image processing apparatus so as to generate a reflective light with substantially identical brightness.

In accordance with a first aspect of the present invention, there is provided a light reflecting structure for use in a light-emitting module of an image processing apparatus. The light reflecting structure comprises a light source and the at least one reflector. The reflector is disposed in the vicinity of the light source, and comprises a plurality of reflecting regions and shading regions discretely arranged at a surface thereof to respectively reflect and shelter the light emitted from the light source, thereby generating a reflective light with substantially identical brightness.

In an embodiment, the reflector is disposed besides or under the light source.

In an embodiment, the shading regions have gradual dense distributions from both sides to the middle portion of the reflector.

In an embodiment, the shading regions have gradual area distributions from both sides to the middle portion of the reflector.

In an embodiment, the shading regions can be gray scale images with gradual dense distributions from both sides to the middle portion of the reflector.

In an embodiment, each of the shading regions has a stripe shape, a circular shape, a wavy shape, an elliptic shape, a triangular shape or a rectangular shape.

In an embodiment, the light source is a linear cathode-ray tube lamp.

In an embodiment, the reflector is a reflective sticker.

In an embodiment, the shading regions are printed or paint-sprayed on the surface of the reflector.

In an embodiment, the image processing apparatus is a scanner, a printing machine, a copying machine or a facsimile machine.

In accordance with a second aspect of the present invention, there is provided a light reflecting structure for use in a light-emitting module of an image processing apparatus. The light reflecting structure comprises a light source and at least one reflector. The reflector is disposed in the vicinity of the light source, and comprises a plurality of reflecting regions and shading regions discretely arranged at a surface thereof to respectively reflect and shelter the light emitted from the light source, thereby generating a reflective light with substantially identical brightness. Especially, the shading regions have gradual dense distributions from both sides to the middle portion of the reflector.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a light reflecting structure for use in a light-emitting module of a scanner according to a preferred embodiment of the present invention; and

FIGS. 2(a) and 2(b) are schematic top views illustrating two examples of the reflector used in the light reflecting structure of FIG. 1.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention is directed to a light reflecting structure. Such a structure can be used in an image processing apparatus such as a scanner, a printing machine, a copying machine or a facsimile machine. The light generated from this light reflecting structure can be evenly projected onto the scanned objected.

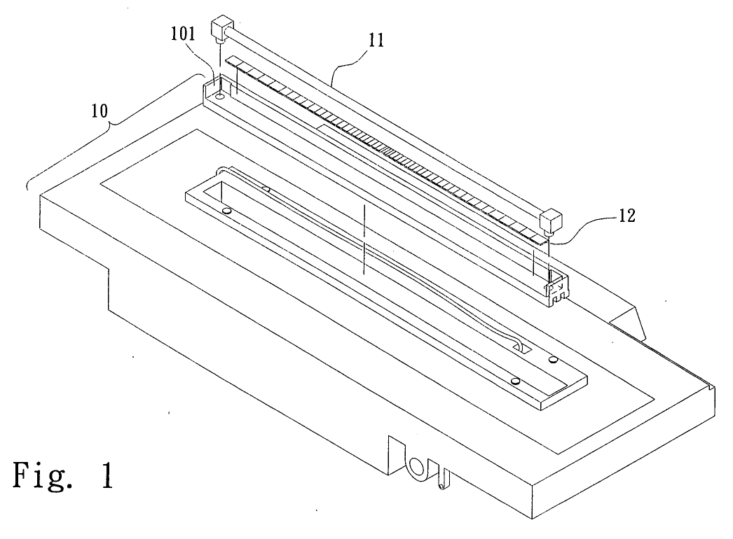

Referring to FIG. 1, a schematic view of a light reflecting structure according to a preferred embodiment of the present invention is shown. The light reflecting structure principally comprises a light source 11 and a reflector 12. The light source 11 is disposed with a trench 101 of the light-emitting module 10. In this embodiment, the light-emitting module 10 further comprises a reflective mirror, a lens set, and a photoelectric conversion device such as a charge coupled device (CCD). The functions of the reflective mirror, the lens set and the CCD element are similar to those described above. An example of the light source 11 used in the present invention is a linear cathode-ray tube lamp. The reflector 12 is disposed besides or under the light source 11. The number of the reflector 12 can be more than one. When the scanner is operated, the light emitted by the light source 11 is reflected from the reflector 12 and then projected onto an opaque object placed on a scanning platform (not shown) above the light-emitting module 10. The light reflected from the scanned object is incident into the light-emitting module 10 and reflected by the reflective mirror. By means of the lens set, the light reflected from the reflective mirror is focused on the CCD element and converted into an electric signal in an analog or digital form. In the embodiment of FIG. 1, the light source 11 is disposed above the trench 101 of the light-emitting module 10, and the reflector 12 is attached to the bottom surface of the trench 101. There is a gap between the light source 11 and the reflector 12.

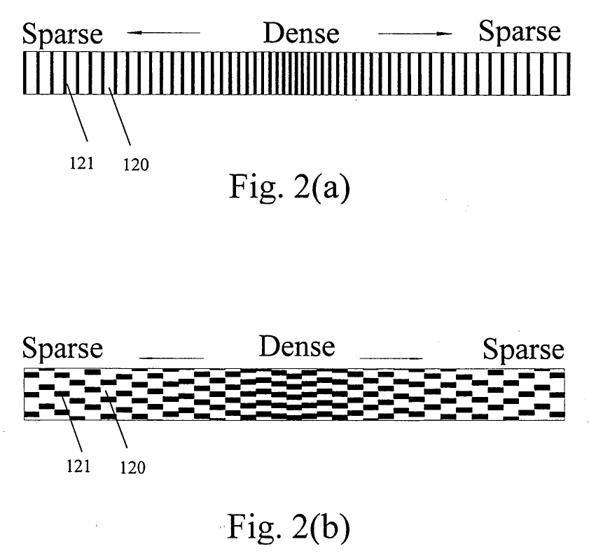

Referring to FIG. 2(a), a schematic top view of a reflector is illustrated. The reflector 12 comprises a plurality of reflecting regions 120 and shading regions 121, which are discretely arranged at the surface of the reflector 12. The light emitted from the light source 11 may be reflected from the reflecting regions 120 but sheltered by the shading regions 121. In other words, only the light incident to the reflecting regions 120 can be reflected and projected onto the scanned object, but the light incident to the shading regions 121 is absorbed and not reflected. In this embodiment, the shading regions 121 comprise several stripes along the width direction of the reflector 12. Especially, these shading regions 121 have gradual dense distributions from both sides to the middle portion of the reflector 12. In other words, the shading regions 121 are relatively denser at the middle portion and relatively sparser at both sides. Since the shading regions 121 at the middle portion are denser than those at the both sides, the light emitted from the middle portion of the light source 11 will be absorbed more. In this way, the brightness of the light from the light reflecting structure, which is a combination of the light source 11 and the reflector 12, will be regulated to substantially identical so as to be uniformly projected on anywhere of the scanned object.

A further embodiment of a reflector is illustrated in FIG. 2(b). The shading regions 121 comprise several segmental stripes along the length direction of the reflector 12 and have gradual dense distributions from both sides to the middle portion of the reflector 12. The shading regions 121 may have any shapes so long as they have gradual dense distributions from both sides to the middle portion of the reflector 12. For example, the shape of the shading regions 121 may be a circular shape, a wavy shape, an elliptic shape, a triangular shape or a rectangular shape. Alternatively, the shading regions 121 may have gradual area distributions from both sides to the middle portion of the reflector 12. That is to say, the area of the shading region 12 for the middle portion is the relatively larger than that for each side.

Furthermore, the density of the shading regions 121 is determined according to the intensity difference between the light emitted from the middle portion and the light emitted from the both side. The shading regions can be printed or paint-sprayed on the surface of the reflector. Alternatively, the shading regions can be gray scale images with gradual dense distributions from both sides to the middle portion of the reflector 12.

Since the shading regions of the reflector are capable of partially sheltering the light emitted from the light source and have gradual dense distributions from both sides to the middle portion thereof, the brightness of the light from the light reflecting structure is regulated to substantially identical. In such way, the light reflect from the light reflecting structure of the present invention can be evenly distributed on the scanned object. Therefore, the scanning quality will be largely enhanced without the need of increasing the length of the light source. In addition, the process for producing the shading portions on the surface of the reflector is simple and cost effective. The shape of the reflector can be arbitrary. Preferably, the reflector is a single-faced sticker in a shape of a long piece. The sticker is easily attached onto the bottom or side surface of the trench.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light reflecting structure for use in a light-emitting module of an image processing apparatus, said light reflecting structure comprising:
a light source;
at least one reflector disposed in the vicinity of said light source, and comprising a plurality of reflecting regions and shading regions discretely arranged at a surface thereof to respectively reflect and shelter the light emitted from said light source, thereby generating a reflective light with substantially identical brightness.

2. The light reflecting structure according to claim 1 wherein said reflector is disposed besides or under said light source.

3. The light reflecting structure according to claim 1 wherein said shading regions have gradual dense distributions from both sides to the middle portion of said reflector.

4. The light reflecting structure according to claim 3 wherein said shading regions have gradual area distributions from both sides to the middle portion of said reflector.

5. The light reflecting structure according to claim 3 wherein the shading regions can be gray scale images with gradual dense distributions from both sides to the middle portion of said reflector.

6. The light reflecting structure according to claim 1 wherein each of said shading regions has a stripe shape, a circular shape, a wavy shape, an elliptic shape, a triangular shape or a rectangular shape.

7. The light reflecting structure according to claim 1 wherein said light source is a linear cathode-ray tube lamp.

8. The light reflecting structure according to claim 1 wherein said reflector is a reflective sticker.

9. The light reflecting structure according to claim 1 wherein said shading regions are printed or paint-sprayed on said surface of said reflector.

10. The light reflecting structure according to claim 1 wherein said image processing apparatus is a scanner, a printing machine, a copying machine or a facsimile machine.

11. A light reflecting structure for use in a light-emitting module of an image processing apparatus, said light reflecting structure comprising:
a light source;
at least one reflector disposed in the vicinity of said light source, and comprising a plurality of reflecting regions and shading regions discretely arranged at a surface thereof to respectively reflect and shelter the light emitted from said light source, thereby generating a reflective light with substantially identical brightness, wherein said shading regions have gradual dense distributions from both sides to the middle portion of said reflector.

12. The light reflecting structure according to claim 11 wherein said reflector is disposed besides or under said light source.

13. The light reflecting structure according to claim 11 wherein said shading regions have gradual area distributions from both sides to the middle portion of said reflector.

14. The light reflecting structure according to claim 11 wherein the shading regions can be gray scale images with gradual dense distributions from both sides to the middle portion of said reflector.

15. The light reflecting structure according to claim 11 wherein each of said shading regions has a stripe shape, a circular shape, a wavy shape, an elliptic shape, a triangular shape or a rectangular shape.

16. The light reflecting structure according to claim 11 wherein said light source is a linear cathode-ray tube lamp.

17. The light reflecting structure according to claim 11 wherein said reflector is a reflective sticker.

18. The light reflecting structure according to claim 11 wherein said shading regions are printed or paint-sprayed on said surface of said reflector.

19. The light reflecting structure according to claim 11 wherein said image processing apparatus is a scanner, a printing machine, a copying machine or a facsimile machine.
